(19) United States
(12) Patent Application Publication
(10) Pub. No.: US 2025/0091521 A1
(43) Pub. Date: Mar. 20, 2025

(54) WINCH AND VEHICLE ACCESSORIES

(71) Applicant: Mitch P. Walk, Temecula, CA (US)

(72) Inventor: Mitch P. Walk, Temecula, CA (US)

(21) Appl. No.: 18/886,788

(22) Filed: Sep. 16, 2024

Related U.S. Application Data
(60) Provisional application No. 63/583,118, filed on Sep. 15, 2023.

(51) Int. Cl. B60R 7/04

(52) U.S. Cl. CPC B60R 7/043

(57) ABSTRACT

A rope includes an alternating braid defining openings spaced apart at intervals along at least a portion of a length of the rope. A longitudinal end of the rope is weavable through the openings to create a securement loop. A winch cover for a winch attached to a vehicle includes a a closable opening on a top of the cover body and configured to enable access to a freespool mechanism of the winch, and a front flap coupled to a front of the cover body and configured to enable selective opening and closing of the front opening. A center bag for vehicle includes a bag body, and a coupler for attaching the bag body to adjacent, spaced apart seats of the vehicle so that the bag body is disposed between the seats.

### CROSS-REFERENCE TO RELATED APPLICATIONS

The present application claims priority to U.S. Provisional Application No. 62/809,076, filed Sep. 15, 2023, the entirety of which is hereby incorporated by reference.

### BACKGROUND OF THE DISCLOSURE

Winches and kinetic ropes are used extensively throughout the world in military, public service, off road, and street vehicles. To this point, there have been two main types of winch line manufactured; one being a braided steel cable, and more recently, a synthetic braided rope line. An exemplary convention winch line attached to winch on a vehicle is indicated at reference numeral 10 in FIG. 1.

With regards to recovery applications, there are also both recovery straps and kinetic rope. The strap is a woven webbing, typically made of nylon for stretching ability, but sometimes woven with polyester (which does not stretch as much) when being utilized as a tow strap as opposed to a recovery strap. A recovery strap is typically flat and wide, usually being between 1 inch and 3 inches wide, but in some instances, that width can exceed 6 inches, while the height rarely exceeds ⅜ inch. Kinetic rope on the other hand is braided and more of a rounded shape, most often being similar in width and height like a winch line. While a webbing strap is woven using a few primary strands on its length, a kinetic rope is braided using yarn twisted into strands which are then twisted into rope. In this application, multiple strands would need to fail in order to break the rope. In addition, recovery strap has end loops that are sewn at either end, allowing the possibility of having the loops fail due to thread breakage.

### SUMMARY OF THE DISCLOSURE

In one aspect, the present disclosure is directed to a rope comprising an alternating braid defining openings spaced apart at intervals along at least a portion of a length of the rope, wherein a longitudinal end of the rope is weavable through the openings to create a securement loop.

In another aspect, the present disclosure is directed to a winch cover for a winch attached to a vehicle. The winch cover comprising a cover body configured to cover the winch. The cover body defines a front opening to access a winch rope or line wrapped around the winch. A closable opening on a top of the cover body is configured to enable access to a freespool mechanism of the winch. A front flap coupled to a front of the cover body is configured to enable selective opening and closing of the front opening. The winch is operable without removing the cover body.

In yet another aspect, the present disclosure is directed to a bag for a seat of a vehicle. The bag comprises a bag body; and a seat coupler secured to the bag body, wherein the seat coupler is configured to couple to a lower, front portion of the seat of the vehicle.

In another aspect, the present disclosure is directed to a center bag for vehicle. The bag comprises a bag body; and a coupler for attaching the bag body to adjacent, spaced apart seats of the vehicle so that the bag body is disposed between the seats.

### BRIEF DESCRIPTION OF THE DRAWINGS

FIG. 1 is a prior art winch rope.

FIG. 2 is one embodiment of a winch or kinetic rope of the present disclosure.

FIG. 3A is the rope on a winch.

FIG. 3B is another embodiment showing the rope on a winch.

FIG. 4 is the rope attached to a tree.

FIG. 5 is the rope as a kinetic rope with each longitudinal end configured as a securement loop.

FIG. 6 is an enlarged longitudinal end of the kinetic rope in FIG. 5.

FIG. 7 is a prevention device for a winch on a vehicle.

FIG. 8 is the rope including a device attached to the longitudinal end of the rope.

FIG. 9 is a winch cover.

FIG. 10 is a body of the winch cover.

FIG. 11 is a bag attached to a front of a seat of a vehicle.

FIG. 12 is a rear view of the bag.

FIG. 13 is a rear view of another embodiment of the bag.

FIG. 14 is a front perspective of yet another embodiment of the bag.

FIG. 15 is a side view of the bag of FIG. 14.

FIG. 16 is the bag coupled to the front of the seat.

FIG. 17 is a MOLLE accessory coupled to a rear of a seat.

FIG. 18 is the MOLLE accessory with a partially closed cover.

FIG. 19 is a center bag coupled to a driver and front passenger seat above a center console.

FIG. 20 is another embodiment of the center bag.

FIG. 21 is a soft top cover.

FIG. 22 is the soft tope cover attached to a vehicle.

### DETAILED DESCRIPTION OF THE DISCLOSURE

### Winch and Kinematic Rope

Although synthetic winch lines and kinetic rope are proven to be superior to their counterparts in most aspects, there are, however, still limitations such as the useful life of the system. The winch systems and methods described herein will provide the benefits of recovery straps and kinetic rope with the longevity of steel winch cables. The systems and methods described herein provide protection against ultraviolet, chemical, and liquid breakdown in order to improve longevity.

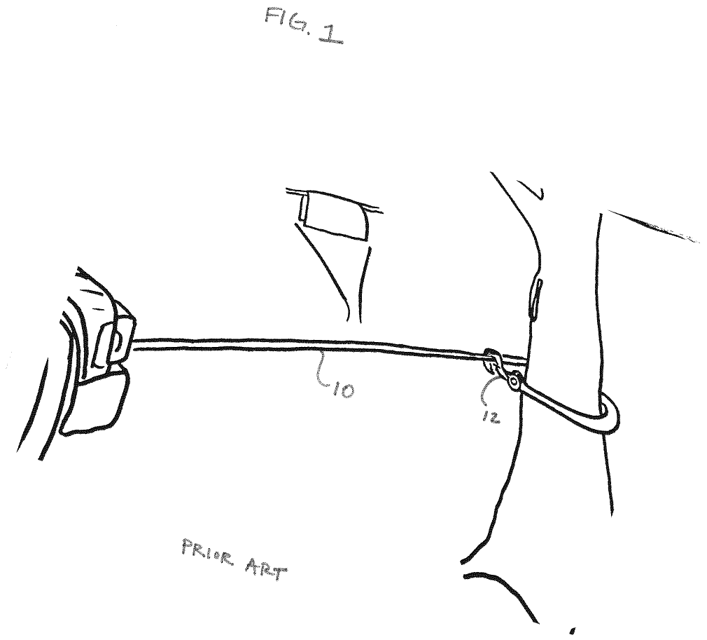

As mentioned above, synthetic winch line is used exclusively in many applications for safety concerns. However, a synthetic line can also prove to be extremely dangerous, even when used correctly. Typically, a hook (e.g., shown in FIG. 1 at reference numeral 12), shackle, or thimble is added to the end of a winch line in order to provide a mechanism that can be attached to another object to assist in pulling a vehicle out of a rut, or pulling a vehicle or other object closer to the winch being utilized. These large objects can be heavy and are typically made from steel, aluminum, or titanium. The weight of these objects can negate the safety aspect of the synthetic line altogether. For example, if the line breaks or the heavy mechanism attached to the end breaks or comes loose, a heavy projectile can propel through the air at a high rate of speed becoming a potentially deadly object that is causing danger to everyone nearby. In addition to this, there are issues with the heavy objects and loops currently used at the ends of winch lines and kinetic straps respectively.

Shackles consist of a horseshoe-shaped outer area that serves as the location for a hook, and there is typically a pin that feeds through one side of the opening, across to the other side where it is threaded. At this point, the pin is threaded into the opening of the horseshoe in order to hold it firmly in place. Unfortunately, shackles can become rusted and bent, and are oftentimes very difficult and time consuming to break loose and to use. The shackles have also been known to break under pressure proving to be a dangerous tool in many applications.

Hooks at the end of winch lines have been known to break loose from the line itself, which creates a safety hazard. In addition, oftentimes, users wrap a winch line around an object and place the hook around the line to hold it in place as tension starts to be placed on the winch line (FIG. 1). This causes the hook to support the weight in awkward position much of the time, and very often, the load exceeds the working load limit (WLL) of the hook itself at those incorrect angles. Hooks can also allow the winch line to slide out of the hook, not only allowing the hook to rocket through the air, but also to lose tension in a quick instant, which can cause the object being winched to fall, or careen backwards. This can sometimes be catastrophic. When done correctly, and line damper is hung over the winch line to weight it down in case of a failure. However, these are rarely used and can only provide a limited safety aspect to this set up.

Winch thimbles are devices attached to the end of a winch line and are the newest and safest of the aforementioned attachments. Unfortunately, they often rely on a shackle being used on the end of them, and/or they also have a hook. More importantly, they too are a very heavy object at the end of a heavily-tensioned line, causing them to also be safety hazards.

Kinetic ropes, also known as tug boat ropes can be extremely thick and thus very strong due to the multiple layers of interlaced rope. They typically have loops on either end so that they can be wrapped around an object, and then the opposite end of the rope can be fitted through the end loop and pulled through. The issue is that the length is not adjustable, and the opposite end of the rope must be attached to another object via a hook or shackle, of which can be dangerous and sometimes difficult to use as explained above.

The systems and methods described herein provide a safer alternative to the current winching and kinetic rope scenarios. Instead of requiring the addition of a heavy object (e.g., metal hook or saddle) to the end of the winch line or rope, it is possible to create a line that will weave through itself quickly and easily at any point in the line itself, while proving to be much safer due the deletion of heavy objects attached to the end.

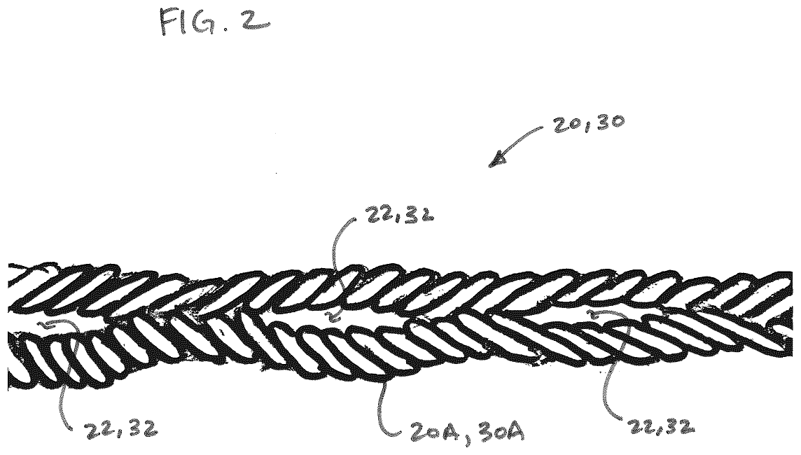

Referring to FIGS. 2-4, in the illustrated embodiment, a winch line (or rope) or kinetic rope 20, 30 includes an alternating braid 20A, 30A, respectively, defining openings 22, 32, respectively, slightly larger than a thickness or circumference of the winch line or rope throughout the length of the winch line or rope (or at respective ends thereof) at intervals. A user can wrap the braid 20A, 30A around another object and weave the end through the alternating openings 22, 32 a number of time (e.g., three to four times) in order to create a securement that is at least as strong as the line/rope 20, 30 itself. Once woven though the openings, 22, 32 in a predetermined number of times, friction will inhibit the end from coming loose and disengaging from the openings regardless of the amount of tension placed on the line/rope. In addition, once winching/towing has been completed, the user can simply un-weave the line/rope from the openings 22, 32 to remove the line/rope from the object. In this application, not only is the user able to provide a much safer winching/towing strategy, but also a much quicker and easier one.

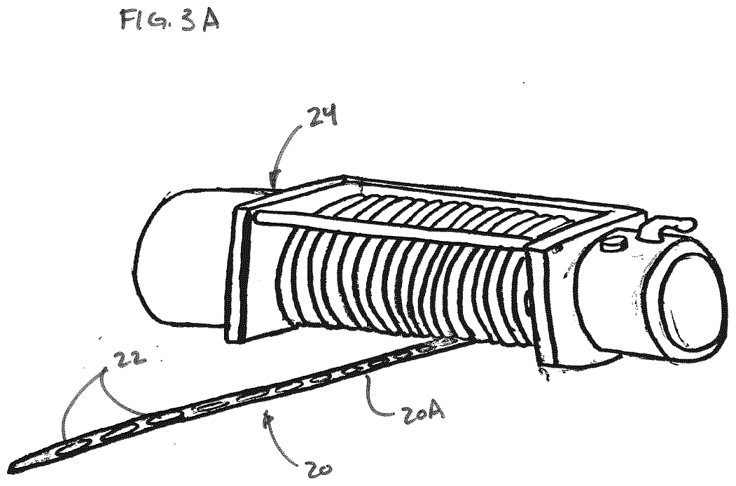

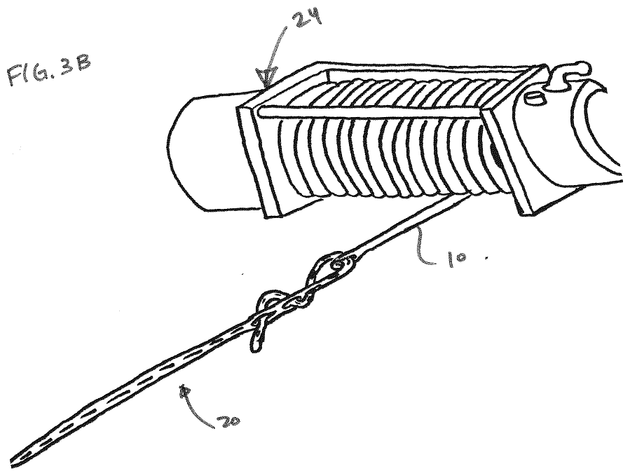

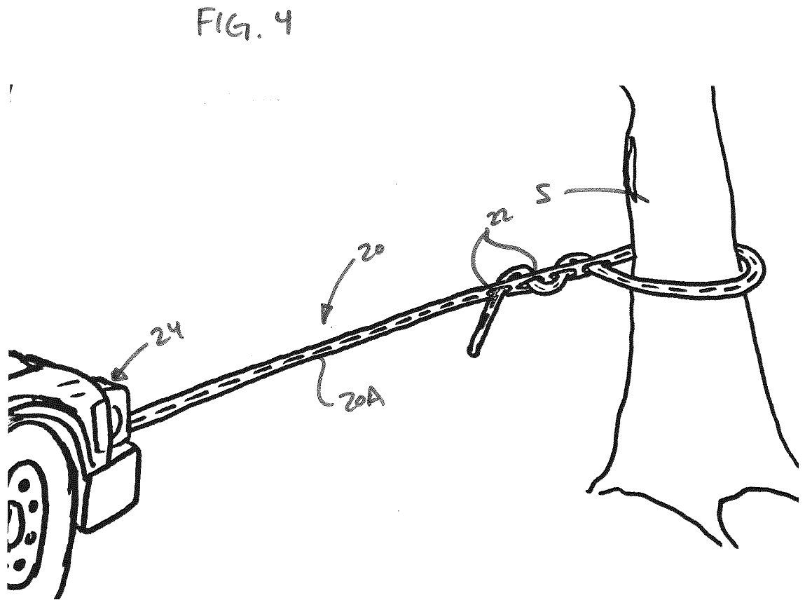

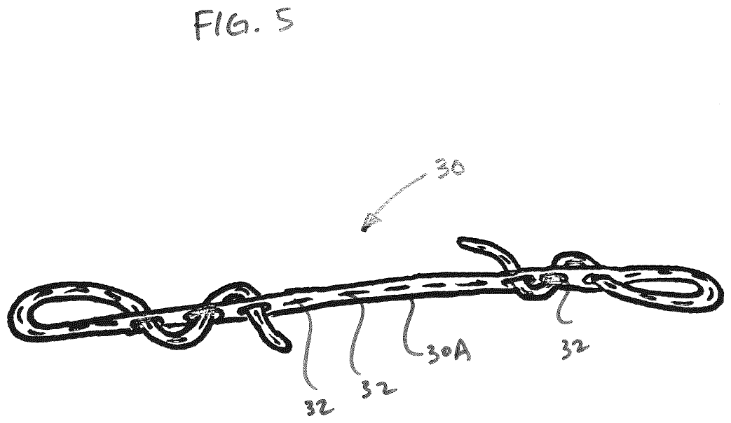

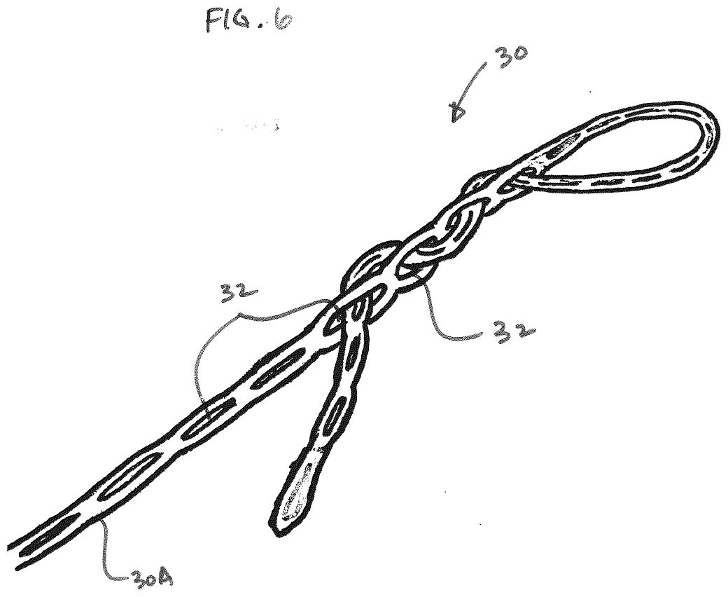

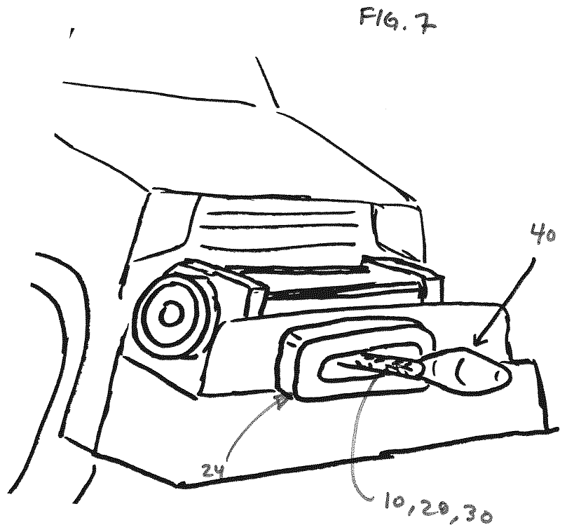

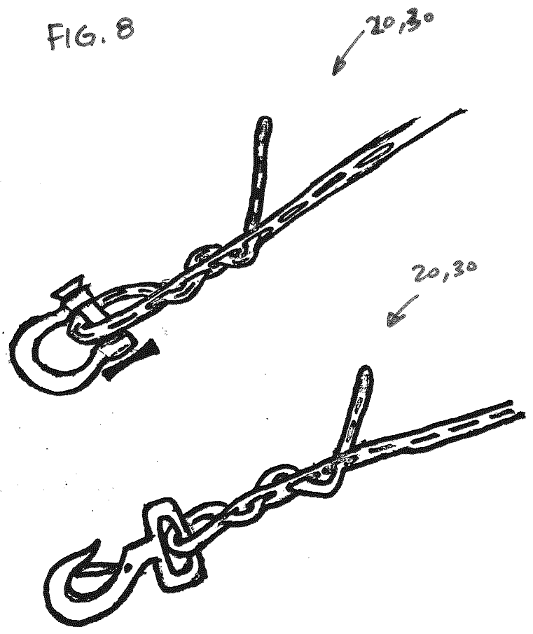

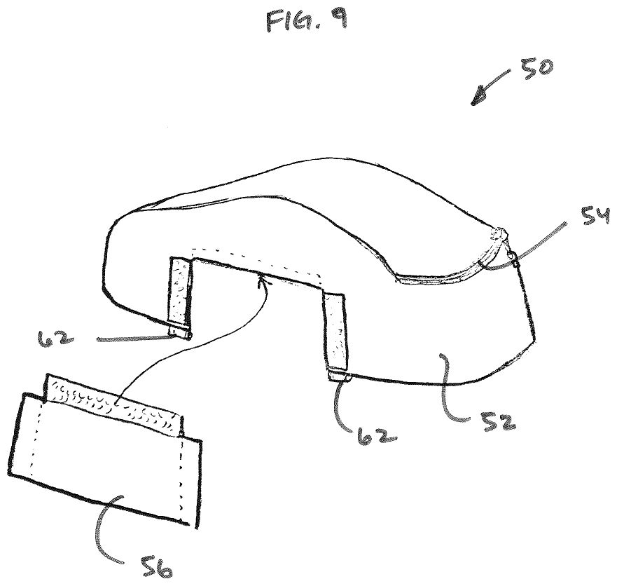

Referring to FIGS. 3A-4, the winch line 20 is shown in operation. In FIG. 3A, the winch line 20 is wrapped around a drum (hidden) of a winch 24. Alternatively, as shown in FIG. 3B, the winch line 20 is attached to a convention winch line 10, which is in turn wrapped around the drum of the winch 24. In this example, the winch line 20 is secured to the convention winch line 10 by serpentining (i.e., weaving) the end of the line through the openings 22 to form a secured loop, in the same manner as the line would be secured to another object. In this way, the winch line 20 can be added to an existing winch line 10. As shown in FIG. 4, in either embodiment, the free end of the winch line 20 opposite the winch 24 is secured to a fixed structure S (e.g., a tree or other structure) by wrapping the free end around the structure in a loop and then securing the loop by serpentining (i.e., weaving) the free end of the line through the opening 22.

Referring to FIGS. 5 and 6, the kinetic rope 30 is shown in operation. FIG. 5 shows the kinetic rope 30 with each end forming a secured loop by serpentining (i.e., weaving) the respective ends of the line through the openings 22. FIG. 6 is an enlarged end of the kinetic rope showing one of the secured loops.

Referring to FIG. 7, another feature of the disclosure is a retention tip 40 secured to a free end of the winch line 10, 20, 30 to provide a stop for the winch line. When the winch line 10, 20, 30 is no longer in use, and is being retracted back into the spool 24, the removable or semi-removable retention tip 40 keeps the line from being pulled all the way into the spool, so that it is ready for the next use. In some embodiments, the retention tip 40 is manufactured from any lightweight material such as, but not limited to, rubber, plastic, or delron.

Referring to FIG. 8, in the event that a user wants to attach to a hook, shackle, or other device, the system allows for a quick and easy attachment method due to the easy on/off application explained here-in (FIG. 104).

Although simple in design, an open-braided winch line and rope can solve many safety and time constraint issues when winching and when using kinetic rope.

### Winch and Winch Line Protection

Winch cable and synthetic winch line should be protected from harmful UV rays and liquids that can damage and weaken them. Currently, winch covers solely provide protection from the elements. However, these are oftentimes very difficult to remove in order to perform winching duties. Sometimes, this can take in excess of 5 minutes prior to being able to utilize a winch. This can prove very costly in terms of safety in hazardous road conditions and in military or race applications where time is of the essence. Furthermore, winch covers are often forgotten about and lost after winching due to the fact that they are sometimes afterthoughts. This can result in frozen lines and other dilemmas arising creating the winch useless until a replacement is found. Due to the fact that the system described herein includes a cover never needs to be removed, the cover cannot be forgotten or lost. In order to solve these issues, a winch cover that never needs to be removed, yet provides all of the UV, weather, and liquid protection of other winch covers is described herein.

Referring to FIGS. 9 and 10, a fixed winch cover system constructed according to the teachings of the present disclosure is generally indicated at reference numeral 50. The winch cover system 50 includes a cover body 52, and one or more zippered (or otherwise closeable/openable) openings 54 on top of the body to provide easy access to both the freespool mechanism of the winch which needs to be turned and disengaged in order to pull out the line, (basically a neutral position on a clutch), and then turned back and re-engaged (in gear) in order be ready for use. Utilizing the same opening 54 or a separate opening, users can access the electronics area in order to utilize their wired winch remote control. A front flap 56 is secured down to on the front portion of the winch body 52 to cover the winch line from the elements and can be lifted out of the way or removed in order to allow the winch to perform without the cover being at risk of getting caught in the spool. The flap 56 can be totally removed for applications in which the winch is attached inside a bumper and the flap is not necessary and difficult to access. This removable flap 56 can be attached and detached in various way, including, but not limited to velcro, zippers, and snaps. It can also be made to fold into the bottom of the winch cover in the same way, so as not to necessarily need to be removable.

As shown in FI. 10, a mesh 60 or open back is used on the back side of the winch cover body 52 not only to dissipate heat generated by the winch to prevent overheating, but also to allow easy evaporation of water or other liquids that could collect inside under the winch and/or winch cover.

In one or more embodiments, as shown in FIG. 9 for example, straps 62 are used on the undersides of the winch cover body 52 in order to facilitate easy installation on the winch and to hold it securely in place. In some embodiments, the straps 62 are flexible and elastic, however, it should be noted that relatively rigid straps could be utilized or other non-elastic strap may be used. Furthermore, in one embodiment, paracord is included to weave through loops sewn to the front side and out through grommets in the back, allowing a user to tie or buckle the winch cover in place to serve as an extra securement method from wind or theft.

### Lower, Front Vehicle Seat Bag

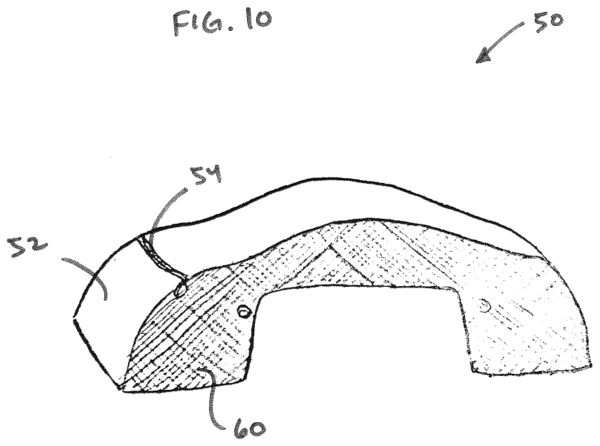

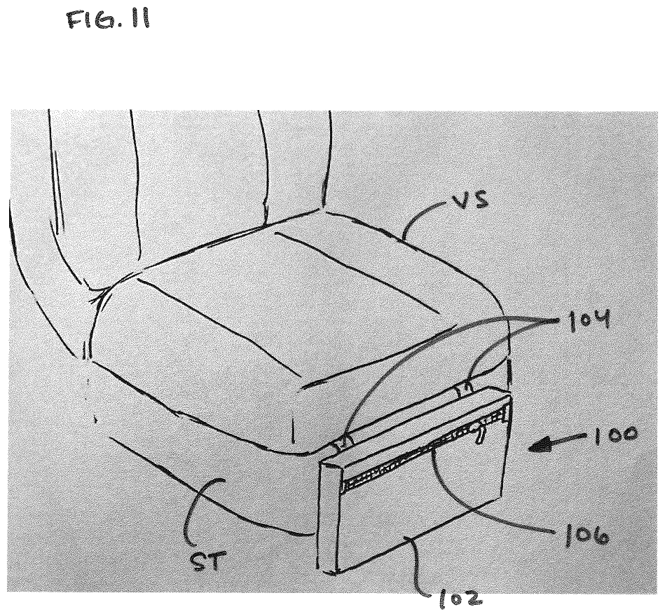

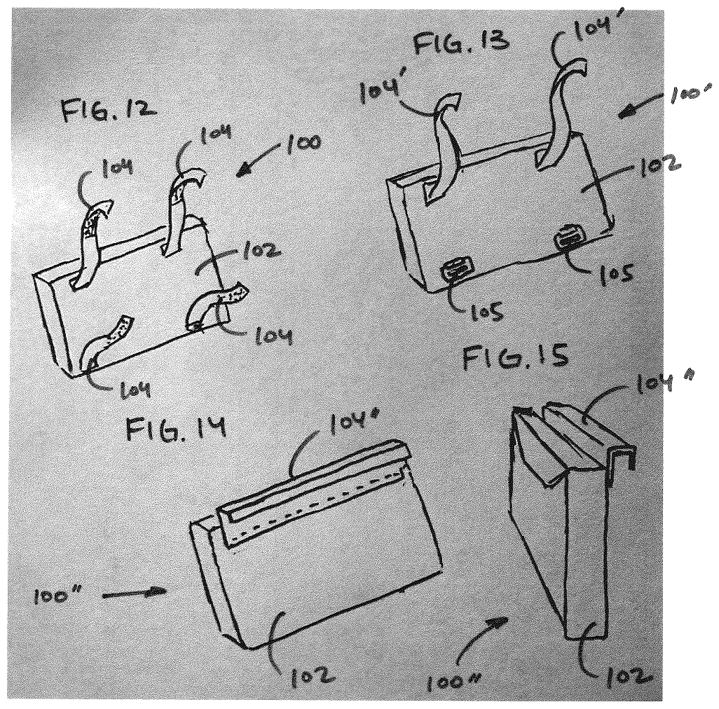

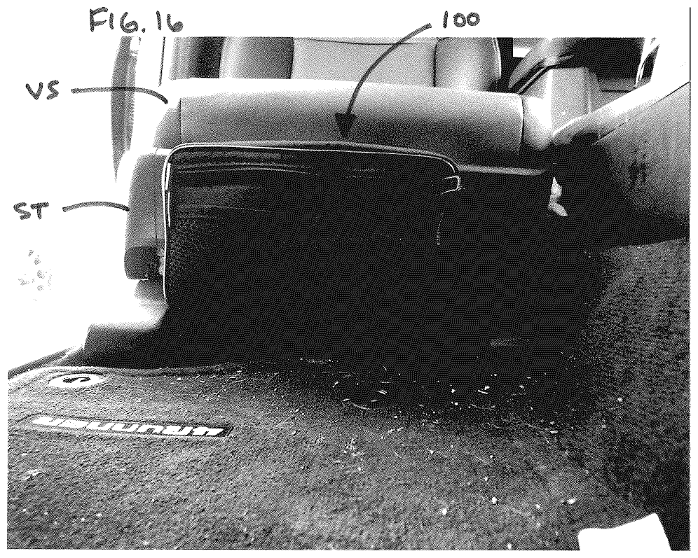

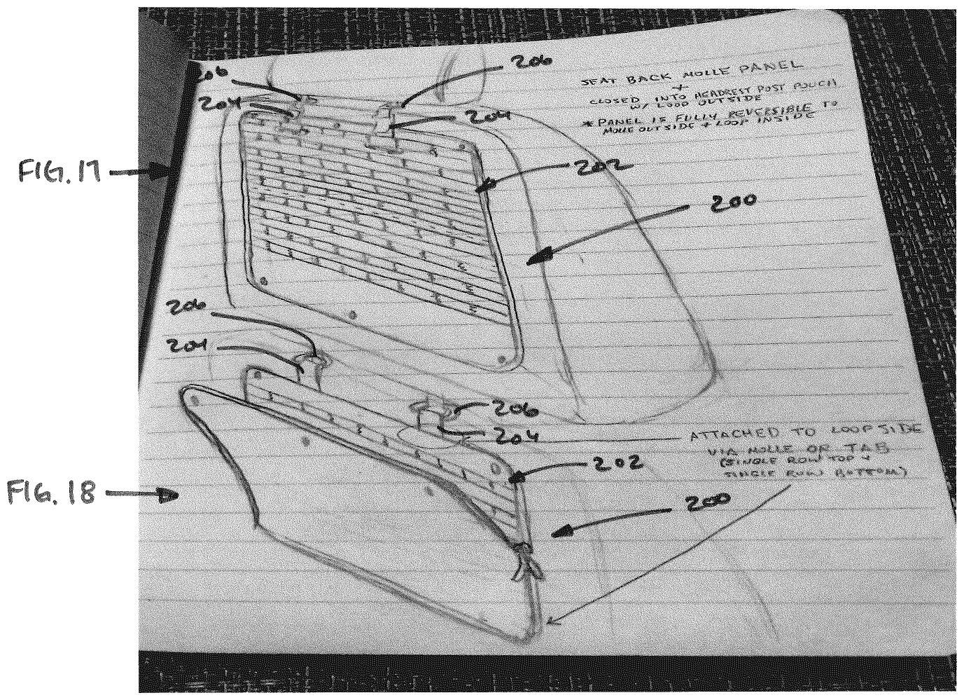

Referring to FIGS. 11, 12 and 16, a vehicle seat bag configured to couple to a vehicle seat VS is indicated general at reference numeral 100. In particular, the seat bag 100 is configured to be coupled to front lower seat trim ST of the seat VS. The seat bag 100 includes a bag body 102 and a seat coupler (e.g., one or more straps 104) on a back side of the body for coupling the bag body to the seat VS, more specifically the front lower seat trim ST. The bag body 102 may be formed from flexible material defining an interior compartment. The bag body 102 may be opened and recloseable by a zippered opening 106 or other components for opening and closing the interior compartment. The one or more straps 104 are configured to wrap around and secure to the front lower seat trim ST. In the embodiment in FIG. 12, the seat bag 100 includes two pairs of upper and lower strap portions that are removable secureable to one another to couple to the front lower seat trim ST. The straps 104 includes fasteners, e.g., hook and loop fasteners, or other types of fasteners. In the embodiment in FIG. 13, straps 104′ are fastenable to buckles 105 attached to the back side of the body 102. In the embodiment in FIGS. 14 and 15, instead of straps the seat coupler includes a clip or hook 104″ that clips or hooks on to the front lower seat trim ST.

### MOLLE Panel for Back of Seat

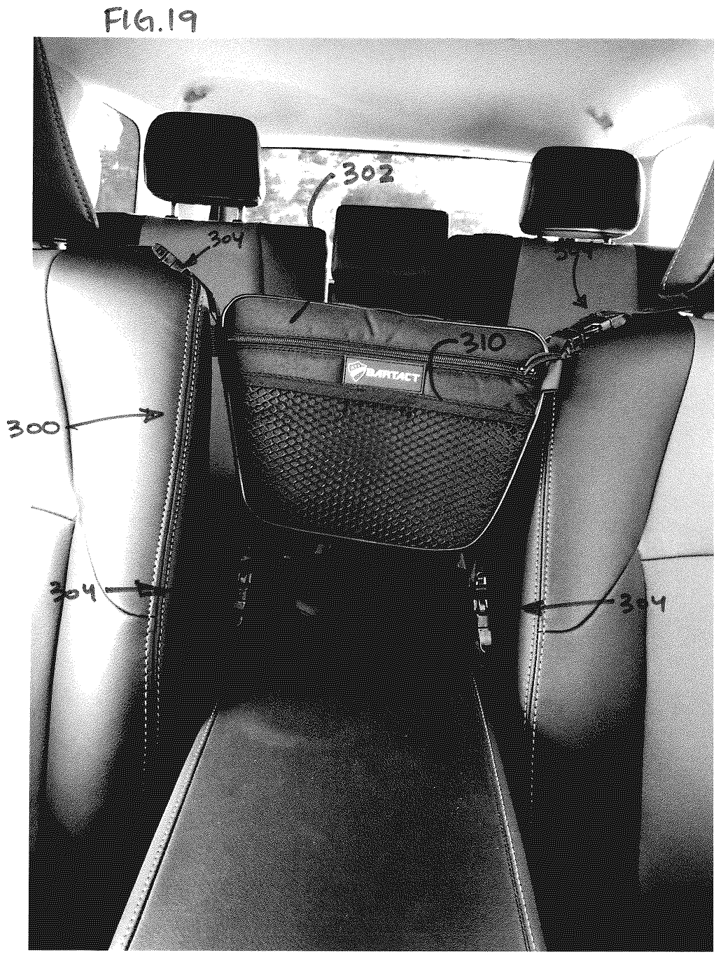

Referring to FIGS. 17 and 18, a MOLLE panel is indicated generally at reference numeral 200. The panel 200 includes a MOLLE body 202 and a seat coupler. In the illustrated embodiment the seat coupler includes straps 204 with rings 206. Seat head posts are receivable through the rings 206 to couple the panel 200 to the seat at a back side thereof.

### Center Bag

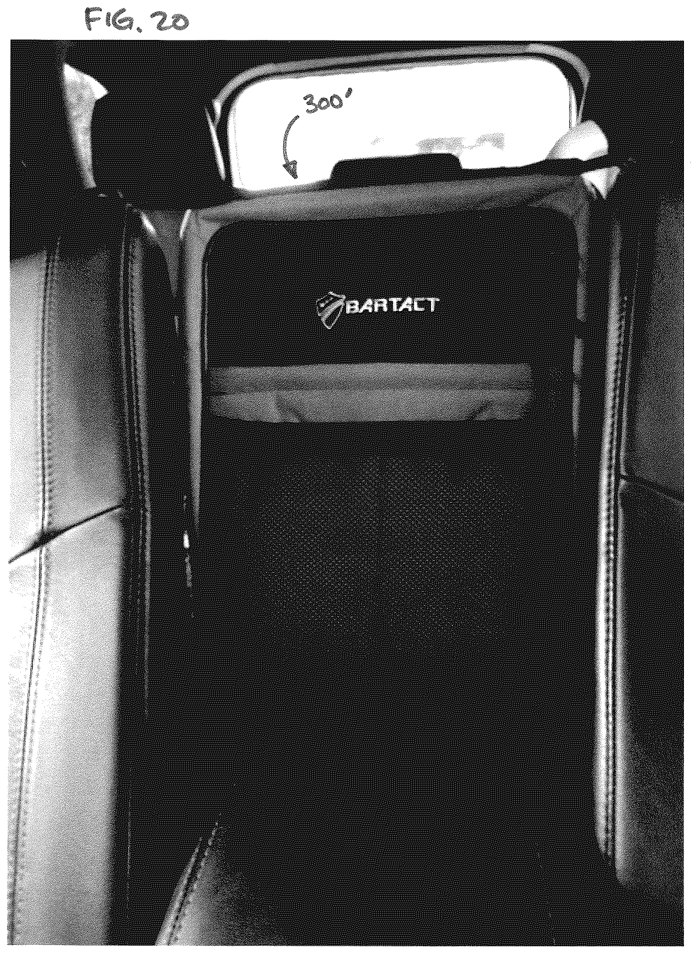

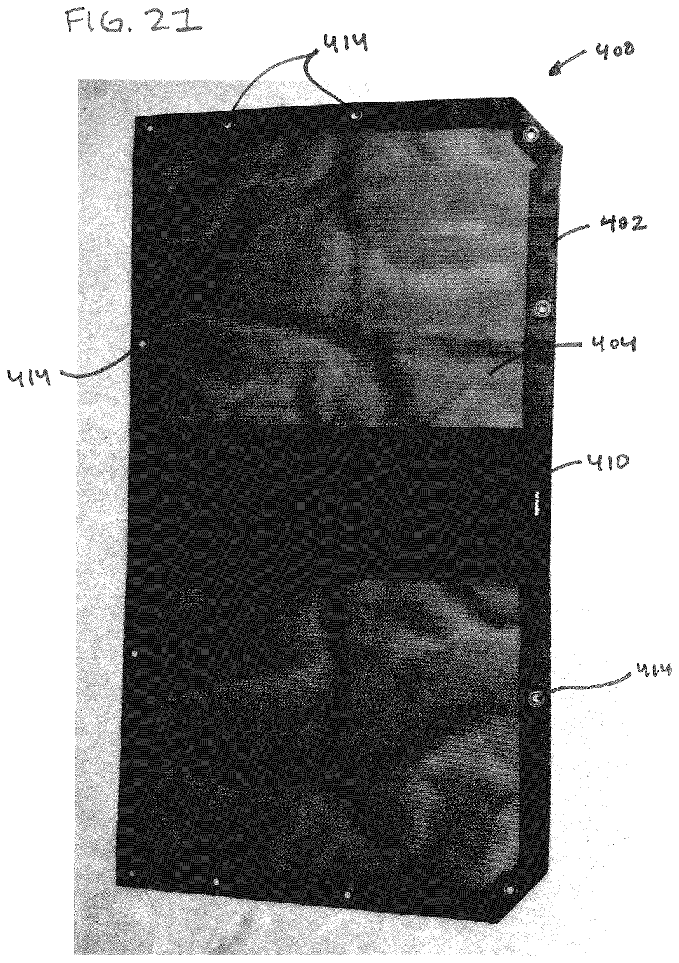

Referring to FIGS. 19 and 20, a center bag constructed according to the teachings of the present disclosure is configured to be coupled to adjacent seats to hang the center bag generally between the seats. Referring to FIG. 19, one embodiment of the center bag is generally indicated at reference numeral 300. The center bag 300 includes a bag body 302 with a reclosable opening (e.g., zippered or Velcro opening) to enable access to an interior compartment, and at least one coupler (e.g., straps 304) for coupling the bag body to adjacent seats. The bag body 302 may be made from generally flexible material forming panels that are secured to one another to define the interior compartment. A netted pouch 310 may be provided on a front panel of the body 302. The straps 304 of the illustrated center bag 300 includes left and right upper straps and left and right lower straps. The upper straps are configured to couple to the respective head rests of left and right seats. For example, the upper straps may include a ring or loop at its free end that is configured to receive a post of the headrest therein to secure the upper straps to the seats. The lower straps are configured to couple to a lower portion of the seats or a center console. For example, the lower straps may include a hook (or other coupler) configured to hook or otherwise couple to the seat or the center console.

Each of the upper and lower straps are flexible and may be non-elastic. The lengths of the upper straps are adjustable, such as by incorporating a buckle in the strap. In addition, each of the straps includes a side quick-release buckle clip to enable bag body 302 to be quickly released from the seats while leaving portions of the straps coupled to the seats so that the center bag can be quickly recoupled to the seats. The center bag 300 may be configured to be used as a personal item for carrying after it is released from the seats. For example, the center bag may be configured as a backpack (see center bag 300′ in FIG. 20) or other carry item. The center bag 300 may also be configured as a barrier between the seats (e.g. drive and passenger seats), such as a pet barrier to inhibit pets from climbing over the center console to the front seats. The center bag 300′ effectively takes up the open area between the front seats and the center console.

### Soft Top Cover

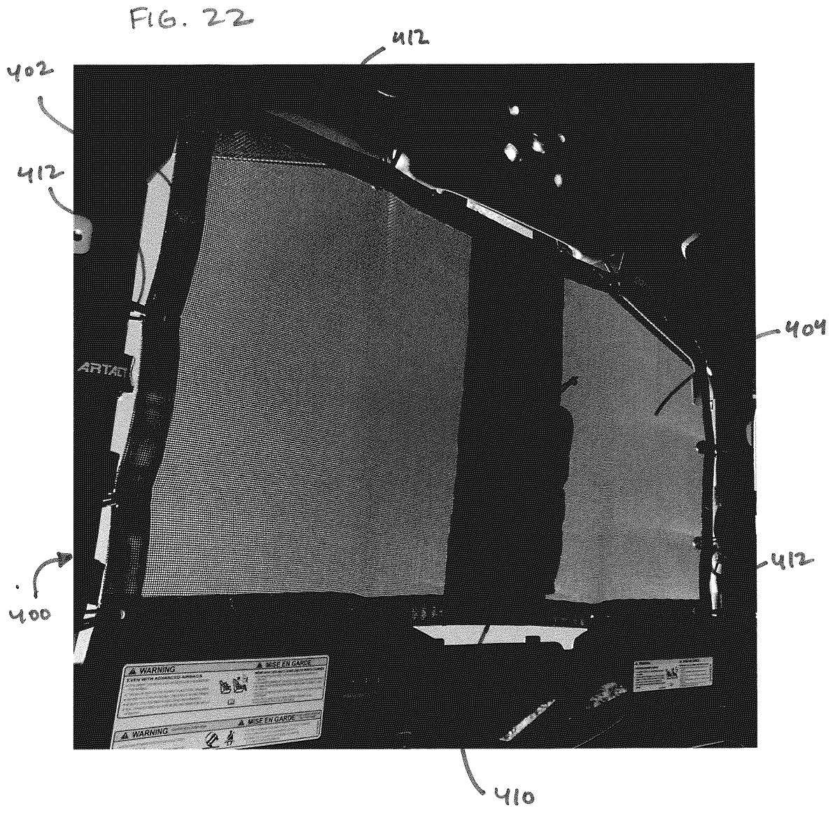

Referring to FIGS. 21 and 22, a soft top cover (e.g., a shade top) 400 is configured to be coupled to a roof of the vehicle to cover an opening in the roof. The cover 400 is generally flexible with a generally rectangular footprint. Reinforced portion 402 extends around the perimeter, and a screen portion 404 is within the perimeter to reduce the amount of sunlight passing therethrough into the interior of the vehicle to provide shade to the occupants, as seen best in FIG. 22. A center portion of the cover 400 includes an accessory 410, such as a MOLLE system and/or a reclosable bag. The accessory 410 bisects the screen portion 404. The cover 400 is couplable to the vehicle using one or more couplers 412 (e.g., clips or bands; FIG. 22) inserted through grommets 414 secured around the perimeter on the reinforced portion 402.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A rope comprising:
an alternating braid defining openings spaced apart at intervals along at least a portion of a length of the rope, wherein a longitudinal end of the rope is weavable through the openings to create a securement loop.

2. The rope set forth in claim 1, wherein the rope is free from an attachment device on the longitudinal end of the rope.

3. The rope set forth in claim 1, wherein the rope is configured as a winch rope and suitable to be wrapped around a fixed object before weaving the longitudinal end through the openings to provide an anchor point.

4. The rope set forth in claim 3, in combination with a winch, wherein the rope is wound on the winch.

5. The rope set forth in claim 4, in further combination with a vehicle, wherein the winch is secured to the vehicle.

6. The rope set forth in claim 3, further comprising a retention tip secured to the longitudinal end to provide a stop for the winch rope and inhibit the longitudinal end of the rope from being pulled into the winch.

7. The rope set forth in claim 1, wherein the rope is configured as a kinetic rope and suitable for attaching a device at the longitudinal end of the rope by weaving the longitudinal end of the rope through the openings to create a securement.

8. The rope set forth in claim 7, in combination with the device secured to the longitudinal end of the rope.

9. A method of using the rope set forth in claim 1, the method comprising:
providing a winch attached to a vehicle, wherein the rope is wrapped around the winch;
wrapping the longitudinal end of the rope around a fixed object;
securing, after said wrapping, the longitudinal end of the rope through at least some of the openings to secure the rope to the fixed object to provide an anchor point.

10. The method set forth in claim 9, further comprising operating the winch after said securing.

11. A winch cover for a winch attached to a vehicle, the winch cover comprising:
a cover body configured to cover the winch, the cover body defining a front opening to access a winch rope or line wrapped around the winch;
a closable opening on a top of the cover body and configured to enable access to a freespool mechanism of the winch; and
a front flap coupled to a front of the cover body and configured to enable selective opening and closing of the front opening, whereby the winch is operable without removing the cover body.

12. A bag for a seat of a vehicle comprising:
a bag body; and
a seat coupler secured to the bag body, wherein the seat coupler is configured to couple to a lower, front portion of the seat of the vehicle.

13. The bag set forth in claim 12, wherein the bag body includes flexible material defining an interior of the bag body.

14. The bag set forth in claim 12, wherein the seat coupler includes straps configured to wrap around a secure to a front lower seat trim of the seat.

15. The bag set forth in claim 12, wherein the seat coupler includes a clip that is configured to hook onto a front lower seat trim of the seat.

16. A center bag for vehicle comprising:
a bag body; and
a coupler for attaching the bag body to adjacent, spaced apart seats of the vehicle so that the bag body is disposed between the seats.

17. The center bag set forth in claim 16, wherein the coupler includes upper left and right straps configured to couple to respective headrests of the adjacent, spaced apart seats.

18. The center bag set forth in claim 17, wherein the coupler further includes lower left and right straps configured to couple to respective lower portions of the adjacent, spaced apart seats or a center console of the vehicle.

19. A method of installing the center bag of claim 16 in a vehicle, the method comprising:
coupling the center bag to the adjacent, spaced apart seats using the coupler so that the bag body is disposed between the seats.

20. The method of installing the center bag set forth in claim 19, wherein said coupling the center bag comprises coupling the center bag to driver and front passenger seats so that the bag body is above a center console and between the drive and front passenger seats.
